(19) United States
(12) Patent Application Publication
(10) Pub. No.: US 2011/0318256 A1
(43) Pub. Date: Dec. 29, 2011

(54) Method of Continuously Synthesizing Oriented Carbon Nanotubes and Apparatus for Continuously Synthesizing Same

(75) Inventors: Yoshikazu Nakayama, Suita-shi (JP); Toru Sakai, Tokyo (JP); Takeru Yajima, Tokyo (JP); Yoichi Urakawa, Tokyo (JP); Kenichi Kon, Tokyo (JP); Takeshi Nagasaka, Tokyo (JP)

(73) Assignees: TAIYO NIPPON SANSO CORPORATION, Shinagawa-ku, Tokyo (JP); OSAKA UNIVERSITY, Suita-shi, Osaka (JP)

(21) Appl. No.: 13/256,614

(22) PCT Filed: Mar. 12, 2010
(86) PCT No.: PCT/JP2010/054241

§ 371 Date: Sep. 14, 2011

(30) Foreign Application Priority Data
Mar. 14, 2009 (JP) 2009-062148

(51) Int. Cl. D01F 9/12; B01J 19/00; B82Y 40/00

(52) U.S. Cl. 423/447.3; 422/187; 977/742; 977/843

(57) ABSTRACT

A method and apparatus for continuously synthesizing oriented carbon nanotubes, with which oriented carbon nanotubes can be stably synthesized in large quantities, is presented.

The method and apparatus for continuously synthesizing oriented carbon nanotubes comprise: a coating and drying step in which a catalyst liquid is applied and dried to form a catalyst layer on a substrate surface; a catalyst substrate formation step in which the catalyst layer is heated to form a catalyst substrate having a catalyst particle layer on the substrate surface; a synthesis step in which a raw material gas heated to a temperature equal to or higher than a synthesis temperature for the oriented carbon nanotubes is brought into contact with the surface of the catalyst substrate to synthesize oriented carbon nanotubes; and a collection step in which the oriented carbon nanotubes are collected. In the synthesis step, a carrier gas having a temperature equal to or higher than the synthesis temperature is supplied to the periphery of the raw material gas which is in contact with the surface of the catalytic substrate, or to its front and rear stages. Thus, oriented carbon nanotubes are continuously or intermittently synthesized.

### FIELD OF THE INVENTION

The present invention concerns a method and an apparatus for synthesizing oriented carbon nanotubes continuously or intermittently. More specifically, it concerns a method for continuous synthesis and an apparatus thereof, in which a catalyst particle layer is formed on a substrate while the substrate is transported continuously or intermittently, and oriented carbon nanotubes are synthesized by supplying a heated raw material gas on this catalyst substrate.

### BACKGROUND ART

As a method for synthesizing oriented carbon nanotubes (also referred to as “brush-like CNTs”), there is the catalyst chemical vapor deposition method (CCVD method), in which carbon nanotubes are grown on a catalyst surface by decomposing a raw material gas, such as a hydrocarbon, using a catalyst. In the PCT WO2008 /007750 publication (Patent Document 1), and in SUEKANE Osamu, NAGASAKA Takeshi, NOSAKA Toshiaki, NAKAYAMA Yoshikazu, Applied Physics 13, Volume 73 (2004), No. 5 (Non-Patent Document1), a method for growing brush-like CNTs on a catalyst substrate surface by said CCVD method is described. In Non-Patent Document 1, a method is described, in which oriented carbon nanotubes are produced by heating a catalyst by electric conductive heating through the resistance heating method, while a mixed gas of acetylene, the raw material gas, and helium, the carrier gas, is supplied over the catalyst substrate.

In the present application, “oriented carbon nanotubes” are carbon nanotubes rising densely toward one particular direction on a substrate, and it signifies carbon nanotubes grown toward one particular direction on a substrate. It is known that the general synthetic process of oriented carbon nanotubes comprises the first growth stage of early rapid growth, and the second growth stage in which the growth is relatively gradual and continuous. Various studies have bee done on the growth mechanism of carbon nanotubes, and in Non-Patent Document 1, the growth mechanism in two growth phases is explained.

FIG. 12 is a correlation diagram between the average height and the raw material gas supply time of the oriented carbon nanotubes (referred to in Non-Patent Document 1 as “brush-like CNTs”) described in Non-Patent Document 1. C₂H₂ gas is used as the raw material gas. In Types 1-3, the time variation of the C₂H₂ concentration with respect to the career gas differs from one another, and the time variation of the C₂H₂ concentration becomes more gradual from Type 1 to Type 3. In all of Types 1-3, it is shown that, with the passage of the supply time of the C₂H₂ gas, it switches over from the first step, in which the carbon nanotubes grow quickly, to the second step, in which the growth rate is gradual. However, between Types 1-3, there is a difference in the average height of the grown oriented carbon nanotubes. It is written in Non-Patent Document 1 that it is due to the difference in the time variation of the C₂H₂ concentration with respect to the carrier gas. However, as for the synthetic condition of the oriented carbon nanotubes, no clear information was provided on the time variation and the distribution of the raw material gas concentration.

Also, methods and apparatuses for synthesizing oriented carbon nanotubes in large quantities have been developed. In the Japanese Patent Laid-Open No. 2003-26410 bulletin (Patent Document 2) and the PCT WO03/073440 publication (Patent Document 3), a method is described for continuously synthesizing oriented carbon nanotubes while rotating or moving a catalyst substrate for growing oriented carbon nanotubes.

FIG. 13 is conventional apparatus for manufacturing oriented carbon nanotubes 102 described in Patent Document 3. In this apparatus 102, at the upstream upper side of endless belt 112 rotated by driving drum 110 and auxiliary drum 156, an Fe complex solution is coated on the upper side of endless belt 112 with spray 116. After this, catalyst particles 114 are formed by heating. Furthermore, acetylene gas is supplied as the raw material gas for carbon nanotube at the chemical vapor deposition zone comprising heating furnace 106 and heater 134 arranged inside it and beneath endless belt 112. Carbon nanotubes (CNT) are synthesized with catalyst particles 114 as nuclei, catalyst particles 114 being heated from the bottom with heater 134. Next, the carbon nanotubes on endless belt 112 reaches the transfer zone at auxiliary drum 110 by the movement of the belt. Here, by heating electroconductivity film 104 with heater 105 at or above the softening temperature and at or below the melting temperature, the carbon nanotubes are transferred to the film surface. However, specific and clear information was not disclosed concerning the continuous reaction condition and the transfer of the oriented carbon nanotubes.

### PRIOR ART DOCUMENTS

### Patent Documents

[Patent Document 1] PCT WO2008 /007750 publication

[Patent Document 2] Japanese Patent Laid-Open No. 2003-26410 bulletin

[Patent Document 3] PCT WO03/073440 publication

### Non-Patent Documents

[Non-Patent Document 1] SUEKANE Osamu, NAGASAKA Takeshi, NOSAKA Toshiaki, NAKAYAMA Yoshikazu, Applied Physics 13, Volume 73 (2004), No. 5

### DISCLOSURE OF THE INVENTION

### Problems to be Solved by the Invention

However, in the methods and apparatuses for continuously synthesizing oriented carbon nanotubes shown in Patent Document 2 and Patent Document 3 (shown in FIG. 13), where oriented carbon nanotubes are synthesized continuously by moving a substrate on which a catalyst layer consisting of catalyst particles 114 and others has been formed, the method for maintaining their synthetic condition or a suitable synthetic condition is not made clear. Therefore, it was difficult to synthesize oriented carbon nanotubes stably and in a large quantity. Therefore, in the synthesis of oriented carbon nanotubes, the productivity could not be increased due to not being able to shorten the time for heating the substrates with catalyst and the gas atmosphere of the reaction area to a predetermined temperature, and the time for collecting the produced oriented carbon nanotubes (so-called the takt time at the time of production). Therefore, there was a problem of the difficulty in achieving a decrease in the production cost. Furthermore, in Non-Patent Document 1, it is described that in the catalyst chemical vapor deposition method (CCVD method), the growth of the carbon nanotubes is inhibited upon a contact between the catalyst substrate in the midst of a temperature increase and the raw material gas, resulting in a deterioration of the orientation. However, in a conventional apparatus for continuously synthesizing oriented carbon nanotubes, because the catalyst substrates and the raw material gas are supplied continuously or intermittently, it was difficult to prevent the contact during the temperature increase.

Therefore, the purpose of the present invention is to provide a method for continuously synthesizing oriented carbon nanotubes and the apparatus thereof, that can continuously and stably synthesize oriented carbon nanotubes in a large quantity, in a easily-used configuration, in which the synthetic condition can be easily reproduced when oriented carbon nanotubes are synthesized continuously, while reducing the nanorisk.

### Means to Solve the Problems

The present invention was proposed to solve the above problem, and the first form of the present invention is, in a method for continuously synthesizing oriented carbon nanotubes in which an oriented carbon nanotube is grown on a catalyst substrate surface while one or more catalyst substrate, on which a catalyst particle layer has been formed, are transported continuously or intermittently, a method for continuously synthesizing oriented carbon nanotubes, characterized in that it comprises a coating and drying step in which a catalyst layer is formed on a substrate surface by coating with a catalyst solution and drying, a catalyst substrate formation step in which a catalyst substrate having a catalyst particle layer is formed on said substrate surface by heating said catalyst layer, a synthesis step in which an oriented carbon nanotube is synthesized by placing a raw material gas that has been heated at or above a synthesis temperature of said oriented carbon nanotube in contact with a surface of said catalyst substrate, a collection step in which said oriented carbon nanotube is collected, and in said synthesis step, a carrier gas at or above said synthesis temperature is supplied in a periphery or its front and rear stages of said raw material gas that is placed in contact with a surface of said catalyst substrate.

The second form of the present invention is the method for continuously synthesizing oriented carbon nanotubes of the first form, wherein a synthesis concentration region over said catalyst substrate, in which a concentration of said raw material gas has been set to be equal to or higher than a predetermined concentration for growing an oriented carbon nanotube, is made to be smaller than a synthesis temperature region over said catalyst substrate that has been set to be equal to or higher than said synthesis temperature.

The third form of the present invention is the method for continuously synthesizing oriented carbon nanotubes of the first or second form, wherein an oxide film is formed on a surface of said catalyst layer during said coating and drying step, while an oxidizing gas is supplied or while heating said catalyst layer under an oxidizing gas atmosphere.

The fourth form of the present invention is the method for continuously synthesizing oriented carbon nanotubes of any one of the first to third forms, wherein said substrate is a belt-like substrate, and said oriented carbon nanotube is collected in a state in which it is adhered on said belt-like substrate during said collection step.

The fifth form of the present invention is the method for continuously synthesizing oriented carbon nanotubes of any one of the first to third forms, wherein said collection step is a transfer collection step in which said oriented carbon nanotube is transferred to a transfer member and detached.

The sixth form of the present invention is the method for continuously synthesizing oriented carbon nanotubes of the fifth form, wherein said transfer collection step includes an adhesion step in which said transfer member is placed in contact through surface with and adhered to a carbon nanostructure substrate surface while said oriented carbon nanotube substrate and said transfer member are transported at a same speed, and a transfer step in which said oriented carbon nanotube is transferred to said transfer member by separating while transporting said transfer member and said oriented carbon nanotube substrate so that an angle formed by a surface of said transfer member and said oriented carbon nanotube substrate surface is a predetermined separation angle.

The seventh form of the present invention is an apparatus for continuously synthesizing oriented carbon nanotubes, characterized in that it comprises a substrate transportation means for transporting a substrate for growing an oriented carbon nanotube, a coating and drying portion for forming a catalyst layer by coating a surface of said substrate with a catalyst solution and drying, a heating means for heating a raw material gas and a carrier gas at a temperature equal to or higher than a synthetic temperature of said oriented carbon nanotube, a raw material gas supplying means for supplying said raw material gas and said carrier gas to a surface of a catalyst substrate, a synthesis portion for synthesizing said oriented carbon nanotube by supplying said raw material gas to a surface of said catalyst substrate on which a catalyst particle layer has been formed by heating said catalyst layer, a collection portion for collecting said oriented carbon nanotube from said oriented carbon nanotube substrate, said heating means and said raw material gas supplying means are arranged in said synthesis portion, said raw material gas supplying means comprises one or more raw material gas supply ports and two or more carrier gas supply ports installed at a periphery of said raw material gas supply ports or at their front and rear stages, and said oriented carbon nanotube is synthesized continuously or intermittently.

The eighth form of the present invention is the apparatus for continuously synthesizing oriented carbon nanotubes of the seventh form, wherein a synthesis concentration region is formed in a surface of said catalyst substrate transported to said synthesis portion, in which a concentration of said raw material gas is set to be equal to or higher than a predetermined concentration for growing said oriented carbon nanotube, and said raw material gas supply port and said carrier gas supply port are arranged so that said synthesis concentration region becomes smaller than a synthesis temperature region of said catalyst substrate surface that has been set to be equal to or higher than said synthesis temperature.

The ninth form of the present invention is the apparatus for continuously synthesizing oriented carbon nanotubes of the seventh or eighth form, wherein an oxidizing gas supplying means for supplying an oxidizing gas to said coating and drying portion is installed.

The tenth form of the present invention is the apparatus for continuously synthesizing oriented carbon nanotubes of the seventh, eighth, or ninth form, wherein an adhesive means for placing in contact while transporting a transfer member for transferring said oriented carbon nanotube and said oriented carbon nanotube substrate, so that said transfer member and said oriented carbon nanotube substrate are transported over a predetermined distance in contact condition and adhered, and a separating means for separating while transporting said transfer member and said oriented carbon nanotube substrate so that an angle formed by said transfer member surface and said oriented carbon nanotube substrate surface becomes a predetermined separation angle, are installed in said collection portion.

The eleventh form of the present invention is the apparatus for continuously synthesizing oriented carbon nanotubes of the tenth form, wherein said transfer member is an adhesive tape, and an adhesive strength of said adhesive tape is in a range of 1-100N/10 mm.

The twelfth form of the present invention is the apparatus for continuously synthesizing oriented carbon nanotubes of the tenth or eleventh form, wherein said separation angle is in a range of 30°-45°.

### Effect of the Invention

According to the first form of the present invention, because, in said synthesis step, the carrier gas at or above said synthetic temperature is supplied in the periphery or its front and rear stages of said raw material gas that is placed in contact with the surface of said catalyst substrate, diffusion of the raw material gas and subsequent contact with the catalyst substrate during its temperature increase can be restrained. As described previously, it had been confirmed that the orientation of synthesized oriented carbon nanotubes decreases when raw material gas comes into contact with the catalyst substrate whose temperature is increasing. According to the first form, by the suppression of diffusion of the raw material gas through supplying the carrier gas at the periphery of said raw material gas or its front and rear stages, contact of the raw material gas, to a catalyst substrate whose temperature is increasing and has not reached the synthesis temperature, can be prevented. Therefore, oriented carbon nanotubes whose orientation is high (subsequently referred to as “highly oriented carbon nanotubes”) can be synthesized. Also, said carrier gas, at least until it contacts the surface of the catalyst substrate, is heated together with the raw material gas to the synthesis temperature or above, and it can suppress a contact to the catalyst substrate to the raw material gas that has diffused and cooled, not reaching the synthesis temperature. Said carrier gas may be supplied at the front and rear stages of the raw material gas supplied on the surface of the catalyst substrate, in the way that the raw material gas is bracketed. If the carrier gas is supplied so that it completely surrounds the periphery of said raw material gas, a more stable synthesis concentration region can be formed.

In said coating and drying step, after forming the catalyst layer on the surface of the substrate by coating with a catalyst solution and drying, the catalyst substrate that has a catalyst particle layer on said catalyst surface is formed during said catalyst substrate formation step by heating said catalyst layer. Therefore, a catalyst particle layer whose particle diameter is relatively uniform can be formed. Said catalyst solution is a liquid in which a metal compound that includes a catalyst metal is dissolved or dispersed, and by coating with this liquid and drying, an extremely thin catalyst layer can be formed on the substrate surface. For the coating of catalyst solution, a spray method and an inkjet methods, among others, are used, and the catalyst solution is sprayed or printed. By controlling, among others, the flow rate of the gas for spraying, the flow rate of the film formation liquid, and the nozzle shapes, the film thickness of the coating film can be controlled. Also, even when the substrate surface has an uneven configuration, a coating film can be adhered. By spray print, an arbitrary pattern can be printed on a substrate surface by using a mask, for example. Therefore, it is preferable to use a catalyst solution in which said metal compound is dispersed or dissolved in a solvent with an ample wettability with said substrate. Furthermore, by heating the catalyst layer and granulating it during said catalyst substrate formation step, a catalyst particle layer having a small, and at the same time, uniform particle size can be formed. Therefore, through the synergic effect with the synthetic condition of the first form, oriented carbon nanotubes with high orientation having even more uniform diameter can be synthesized. Also, said catalyst metal is a transition metal such as iron (Fe), cobalt (Co), nickel (Ni), molybdenum (Mo), platinum (Pt) and such, and iron, cobalt, nickel are particularly preferable. Also, it may be a mixture of one kind or two or more kinds among these metals. Furthermore, said metal compound is an organometallic salt or an inorganic metal salt. Among the organometallic salts, for example, acetates, oxalates, citrates and such are included. Among the inorganic metal salts, nitrates, oxo acid salts and such are included. Also, said metal compound may be a mixture of one kind or two or more kinds of these metal salts.

Furthermore, according to the first form of the present invention, because it includes the collection step for collecting said oriented nanotubes, the synthesized oriented carbon nanotubes can be collected as a product. For said substrate, one can use a continuous body or aligned substrates in which one or more substrates are aligned. A catalyst solution is coated on the surface of the continuous body or the aligned substrates, and by drying this, a catalyst layer is formed. As described earlier, in said catalyst substrate formation step, said catalyst layer is heated. The catalyst particle layer is formed and becomes the catalyst substrate. In the present invention, because substrates are supplied continuously or intermittently, catalyst substrates can be formed and supplied sequentially or continuously, so that oriented carbon nanotubes are synthesized continuously or intermittently to be collected. At the time of collection, the synthesized oriented carbon nanotubes can be detached and collected, or they may be collected in a state in which they are bonded to the catalyst substrate. Also, a thread-like carbon nanotube aggregate can be formed by pulling a part of the packed oriented carbon nanotubes, and by spinning this, the oriented carbon nanotubes can be collected. Also, for a substrate comprising the continuous body or aligned in the aligned substrates, it is preferably a ceramic material, an inorganic nonmetal, or an inorganic nonmetal compound among others, that is resistant at or above said synthesis temperature. For example, a quartz plate, a silicon substrate, a silicon wafer, a rock crystal plate, a fused silica plate, a sapphire plate, or a stainless steel plate, among others, can be used.

According to the second form of the present invention, the synthesis concentration region over said catalyst substrate, in which the concentration of said raw material gas has been set to be equal to or higher than the predetermined concentration for growing oriented carbon nanotubes, is made to be smaller than the synthesis temperature region over said catalyst substrate that has been set to be equal to or higher than said synthesis temperature. Because of this, highly oriented carbon nanotubes can be synthesized more reliably. Present inventor, as the result of an intensive study, came to complete the method for synthesizing highly oriented carbon nanotubes by supplying a raw material gas, set at or above said synthesis temperature, in short time and at a suitable concentration.

Said synthesis concentration region is: (1) a region over a catalyst substrate surface on which the concentration of the raw material gas has reached the concentration in which synthesis of oriented carbon nanotubes has become possible (also, simply referred to as “synthesis concentration”), (2) a region included in the concentration distribution, or the range of its full width at half maximum, over the catalyst substrate surface, or (3) a region satisfying both of those conditions. If the raw material gas concentration over the catalyst substrate surface increases steeply, each of the synthesis concentration regions that fulfill the condition in said (1)-(3) indicates approximately one same region on the catalyst substrate surface. Also, the synthesis temperature range indicates a region over the catalyst substrate surface that has reached the temperature in which oriented carbon nanotubes are synthesized from the raw material gas at or above said synthesis concentration (also, referred to simply as “synthesis temperature”).

According to the second form of the present invention, the synthesis concentration region in the catalyst substrate is set smaller in area than said synthesis temperature region. Because of this, the raw material gas that is at or above the synthesis concentration, and in contact with the catalyst substrate, has approximately reached said synthesis temperature. Therefore, the raw material gas at or above the synthesis concentration does not come into contact during a temperature rise. Therefore, on the catalyst substrate, a region is maintained satisfying the synthetic condition concerning the concentration and temperature of the raw material gas. Because of this, the raw material gas comes into contact with a new catalyst substrate surface after said catalyst substrate is moved, and oriented carbon nanotubes are synthesized. That is to say, highly oriented carbon nanotubes can be stably synthesized continuously or intermittently during said synthesis step, by supplying heated raw material gas to a catalyst substrate. Also, in said synthesis concentration region, it is preferable that the raw material gas concentration increases steeply from outside the region. This way, it becomes easy to form a region of raw material gas uniformly satisfying the synthetic condition concerning the concentration and temperature, and highly oriented carbon nanotube can be synthesized more reliably.

According to the third form of the present invention, the oxide film is formed on the surface of said catalyst layer during said coating and drying step, while the oxidizing gas is supplied or heating said catalyst layer under the oxidizing gas atmosphere. Because of this, during said catalyst substrate formation step, one can form a catalyst particle layer having suitable grain diameter and diameter distribution corresponding to the temperature increase rate during the synthesis step. It has been confirmed that the granulation of a catalyst layer in a heated condition occurs relatively uniformly and with a good reliability, by forming an oxide film on the upper side of a catalyst layer. By synthesizing oriented carbon nanotubes by means of a catalyst substrate having this catalyst particle layer, their orientation can be improved.

According to the fourth form of the present invention, said substrate is a belt-like substrate, and said oriented carbon nanotube is collected in a state in which it is adhered on said belt-like substrate during said collection step. Therefore, the synthesized oriented carbon nanotubes can be easily collected. It is preferable that said belt-like substrate is formed from a flexible material, such as a metal material like stainless steel, or a plastic material. This way, the belt-like substrate, on which oriented carbon nanotube is bonded, can be rolled and collected.

According to the fifth form of the present invention, said collection step is a transfer collection step in which said oriented carbon nanotube is transferred to the transfer member and detached. Because of this, oriented carbon nanotubes can be transferred to various transfer members and thus collected, according to the usage purpose of the oriented carbon nanotubes. For example, when an electroconductive transfer member is used, oriented carbon nanotubes can be used as an electronic part such as an electron source, in a state in which they are bonded to the transfer member.

According to the sixth form of the present invention, it includes an adhesion step in which said transfer member is placed in contact through surface with and adhered to a carbon nanostructure substrate surface while said oriented carbon nanotube substrate and said transfer member are transported at the same speed. Therefore, the oriented carbon nanotubes can be bonded strongly to the transfer member. For said transfer member, one can use an adhesive member or a member that softens by heating at relatively low temperature, and by placing them into contact through surface, the transfer can be made more reliable. Furthermore, said oriented carbon nanotube is transferred to said transfer member by separating while transporting said transfer member and said oriented carbon nanotube substrate so that the angle formed by the surface of said transfer member and said oriented carbon nanotube substrate surface is a predetermined separation angle. Because of this, the oriented carbon nanotubes are separated from said catalyst substrate reliably, and at the same time, a continuous transfer can be done smoothly.

According to the seventh form of the present invention, said raw material gas supplying means comprises one or more raw material gas supply ports and two or more carrier gas supply ports installed at the periphery of said raw material gas supply ports or at their front and rear stages. Because of this, the carrier gas at or above said synthesis temperature can be supplied in the periphery of said raw material gas coming into contact with the surface of said catalyst substrate, or in its front and rear stages. It can suppress a diffusion of the raw material gas, and a subsequent contact with the catalyst substrate in the midst of a temperature increase. As previously stated, it had been confirmed that the orientation of synthesized oriented carbon nanotubes decreases if the raw material gas comes into contact with the catalyst substrate in the midst of a temperature increase. According to the seventh form, one can prevent a contact of the raw material gas with the catalyst substrate that has not reached the synthesis temperature and is in the midst of a temperature raise, by restraining the diffusion of the raw material gas through supplying of said carrier gas in the periphery of said raw material gas or its front and rear stages. Therefore, highly oriented carbon nanotubes can be synthesized. Also, said carrier gas is heated with the raw material gas at or above the synthesis temperature, at latest by the time it comes into contact with the catalyst substrate surface. Because of this, one can suppress a contact with the catalyst substrate of the raw material gas that has diffused and been cooled, not reaching the synthesis temperature.

Preferably, said raw material gas supply port is one or more injection ports, or an injection port aggregate consisting of close-packed, small, multiple injection ports. This way, the raw material gas can be supplied to the catalyst substrate surface with more uniform flow rate. Two or more carrier gas supply ports are installed in a way that they surround or bracket the injection port or the injection port aggregate that comprises the raw material gas supply port. Preferably, this carrier gas supply ports also are one or more injection ports, or an injection port aggregate consisting of close-packed, small, multiple injection ports. This way, the carrier gas can be supplied to the catalyst substrate surface with more uniform flow rate. Furthermore, it is preferable that the raw material gas supply port and the carrier gas supply port are arranged so that the raw material gas concentration increases steeply from outside said synthesis concentration region. This way, highly oriented carbon nanotube can be synthesized more reliably.

Furthermore, according to the apparatus of the seventh form, the substrate transportation means is installed for transporting a substrate on which oriented carbon nanotubes are grown, so that said synthesis concentration region is formed on the transported catalyst substrate. Because of this, highly oriented carbon nanotubes can be synthesized continuously or intermittently. Also, in the coating and drying portion in which the catalyst layer is formed by coating a catalyst solution on the surface of said substrate and drying, a spray equipment for spraying the catalyst solution is arranged. By the installation of the control means for the flow rate of the gas for spraying, the flow rate of the film formation liquid, and the nozzle shape, among others, the film thickness of the coating film can be controlled. Furthermore, it is desirable to set up a heating means for drying in the coating and drying portion, to dry the applied catalyst solution.

Furthermore, according to the seventh form, the collection portion for collecting oriented nanotubes from said oriented carbon nanotube substrate is installed, so that the synthesized oriented carbon nanotubes can be collected as a product. For said substrate, one can use a continuous body or aligned substrates in which one or more substrates are aligned. A catalyst solution is coated on the surface of the continuous body or the aligned substrates, and then a catalyst layer is formed by drying it. As stated previously, because substrates are supplied continuously or intermittently, oriented carbon nanotubes are synthesized continuously or intermittently to be collected. Upon collection, the synthesized oriented carbon nanotubes may be detached and collected, or they may be collected in a state in which they are bonded to the catalyst substrate. Also, a thread-like carbon nanotube aggregate can be formed by installing a spinning apparatus for pulling one part of the packed oriented carbon nanotubes, and by spinning this, the oriented carbon nanotubes can be collected.

According to the eighth form of the present invention, said raw material gas supply port and said carrier gas supply port are arranged so that said synthesis concentration region becomes smaller than the synthesis temperature region of said catalyst substrate surface that has been set to be equal to or higher than said synthesis temperature. Because of this, the raw material gas at or above said synthesis concentration almost never comes into contact with said catalyst substrate surface at or below said synthesis temperature, so that highly oriented carbon nanotubes can be synthesized more reliably. As previously stated, by the CCVD method, the growth of carbon nanotubes is inhibited when the raw material gas comes into contact with the catalyst during a temperature increase. There were cases in which synthesis of highly oriented carbon nanotubes became difficult when the synthesis was done while transporting the catalyst substrate. According to the eighth form, a heating means for heating the raw material gas and the carrier gas at or above the synthesis temperature of oriented carbon nanotubes, together with said raw material gas supply port, is installed. Here, the raw material gas at or above said synthesis temperature is supplied at or above a predetermined concentration in a short time. Therefore, highly oriented carbon nanotubes can be synthesized by supplying, in said synthesis portion, the raw material gas to the surface of the catalyst substrate on which catalyst particle layer has been formed by heating a catalyst layer.

According to the ninth form of the present invention, because the oxidizing gas supplying means for supplying an oxidizing gas to said coating and drying portion is installed, a catalyst particle layer having a suitable grain diameter and a diameter distribution can be formed. By forming an oxide film on the upper surface of the catalyst layer, the catalyst layer can be granulated relatively uniformly. Therefore, by synthesizing oriented carbon nanotubes by means of the catalyst substrate concerning the eighth form of the present invention, their orientation can be improved.

According to the tenth form of the present invention, what has been installed is the adhesive means for placing in contact while transporting the transfer member for transferring said oriented carbon nanotube and said oriented carbon nanotube substrate, so that said transfer member and said oriented carbon nanotube substrate are transported over a predetermined distance in contact condition and adhered. By this, the oriented carbon nanotubes can be fixed strongly on the transfer member. Furthermore, what has been installed is the separating means for separating while transporting said transfer member and said oriented carbon nanotube substrate so that the angle formed by said transfer member surface and said oriented carbon nanotube substrate surface becomes a predetermined separation angle. Because of this, oriented carbon nanotubes are separated from said catalyst substrate reliably, and at the same time, a continuous transfer can be done smoothly.

According to the eleventh form of the present invention, because said transfer member is an adhesive tape, and the adhesive strength of said adhesive tape is in a range of 1-100N/10 mm, oriented carbon nanotubes can be transferred relatively easily and reliably. For said transfer member, a commercially available adhesive tape can be used. It has been confirmed that oriented carbon nanotubes can be transferred optimally by the installation of the separating means that separates, while transporting, said transfer member and said oriented carbon nanotube substrate, so that the angle between said transfer member and said oriented carbon nanotube substrate surface becomes the predetermined separation angle, as long as the adhesive strength is within a range of 1-100N/10 mm. According to the tenth form of the present invention, commercially available adhesive tape can be used as a relatively cheap transfer member, because most of the commercially available adhesive tapes have adhesive strength of 100N/10 mm or less. Also, it has been confirmed that a transfer of oriented carbon nanotubes becomes difficult when the adhesive strength is less than 1N/10 mm.

According to the twelfth form of the present invention, because said separation angle is within a range of 30-45°, oriented carbon nanotubes can be separated and transferred more reliably. A possible reason is as follows. Oriented carbon nanotubes that has grown on a catalyst substrate surface fastens relatively strongly toward the direction normal to this surface. When the separation angle, which is the angle formed by the transfer member surface and the surface of the oriented carbon nanotube substrate, is less than 30°, it becomes difficult to separate reliably the oriented carbon nanotubes from the catalyst substrate surface. Also, when the separation angle exceeds 45°, it depends greatly on the flexibility of the transfer member or the substrate. When the flexibility is low, sometimes it becomes difficult to maintain the predetermined angle.

### BRIEF DESCRIPTION OF THE DRAWINGS

FIG. 1 is a process chart of a method for continuously synthesizing oriented carbon nanotubes concerning the present invention.

FIG. 2 is an outlined schematic diagram of an apparatus for continuously synthesizing oriented carbon nanotubes concerning the present invention.

FIG. 3 is a graphical diagram showing the temperature distribution and the acetylene (C₂H₂) concentration distribution on a catalyst substrate surface concerning the present invention.

FIG. 4 is an arrangement drawing of a raw material gas introduction tube and a carrier gas introduction tube concerning the present invention.

FIG. 5 is an outlined schematic diagram of an apparatus for continuously synthesizing oriented carbon nanotubes concerning another embodiment of the present invention.

FIG. 6 is observation images of oriented carbon nanotubes synthesized with an apparatus for continuous synthesis of oriented carbon nanotubes concerning the present invention.

FIG. 7 is photographic figures showing an observation of a transfer condition of oriented carbon nanotubes by a transfer member concerning the present invention.

FIG. 8 is electron microscope (SEM) images of oriented carbon nanotubes transferred to an adhesive tape that is a transfer member concerning the present invention.

FIG. 9 is photographic figures of an observation of transfer condition of oriented carbon nanotubes by a transfer member concerning the present invention.

FIG. 10 is SEM images of the oriented carbon nanotubes transferred by the adhesive tape (6.40N/10 mm adhesive strength) shown in FIG. 9.

FIG. 11 is SEM images of the oriented carbon nanotubes transferred by the adhesive tape (30.6N/10 mm adhesive strength) shown in FIG. 9. FIG. 12 is a correlation diagram between the average height and the raw material gas supply time of the oriented carbon nanotubes described in Non-Patent Document 1.

FIG. 13 is a conventional apparatus for manufacturing oriented carbon nanotubes described in Patent Document 3.

### BEST MODE FOR CARRYING OUT THE INVENTION

In the following, the embodiments of the present invention are explained in detail based on the attached figures.

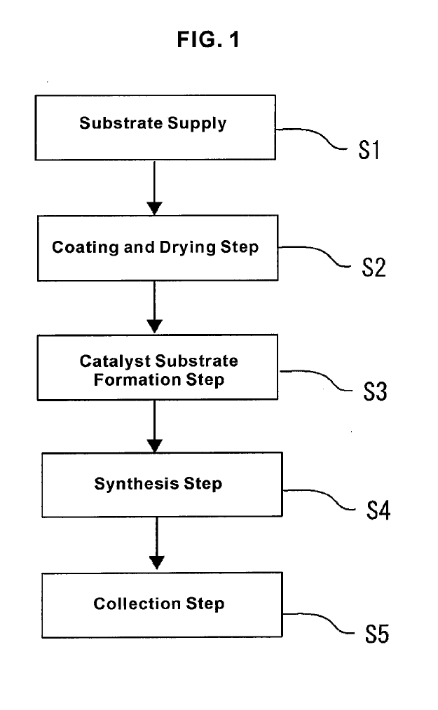

FIG. 1 is a process chart of a method for continuously synthesizing oriented carbon nanotubes concerning the present invention.

### <Substrate Supplying: Step S1>

In the method for continuously synthesizing oriented carbon nanotubes concerning the present invention, substrates are supplied continuously or intermittently. Even while a substrate is being processed during steps S2-S5 discussed below, the next region in the substrate or a plate that becomes a substrate is supplied, and the substrates are supplied until oriented carbon nanotubes are synthesized on all the supplied substrates or a given amount of the substrates, and collected. A substrate comprising a continuous body such as a belt, or plates arranged on a belt, is supplied. Materials such as ceramics materials, an inorganic metalloid, or an inorganic nonmetal compound are preferable, and for example, a quartz plate, a silicon plate, a silicon wafer, a quartz plate, a fused silica plate, a sapphire plate, or a stainless steel plate, among others, can be used.

### <Coating and Drying Step: Step S2>

In the coating and drying step, a catalyst layer is formed on the substrate surface by coating a catalyst solution and drying. Said catalyst solution is a liquid in which a metal compound containing the catalyst metal is dispersed or dissolved, and an extremely thin catalyst layer can be formed on the substrate surface by coating with this liquid and drying. Said metal compound is an organometallic salt or an inorganic metal salt. Among the organometallic salts, for example, acetates, oxalates, and citrates are included, and among the inorganic salts, nitrates and oxo acid salts are included. Also, said metal compound may be a single kind or a mixture of two kinds or more of these metal salts.

Spray methods and inkjet methods are used for the coating of catalyst solution. Here, the catalyst solution is sprayed or printed. The control of the film thickness of the coating film, among others, can be achieved by controlling, for example, the flow rate of gas for atomization, the flow rate of the film formation liquid, and the nozzle shape. Also, a coating film can be bonded even if the substrate surface has an uneven form that is not a plane. By spray print, an arbitrary pattern can be printed on a substrate surface by using a mask. Therefore, it is preferred to use a catalyst solution in which said metal compound is dispersed or dissolved in a solvent with an ample wettability with said plate. Also, in the coating and drying step, the catalyst layer is heated while an oxidizing gas is supplied, and an oxide film is formed on its surface.

### <Catalyst Substrate Formation Step: Step S3>

In the catalyst substrate formation step, a catalyst substrate having a catalyst particle layer is obtained by heating said catalyst layer. That is to say, the catalyst layer is granulated by heating, and the catalyst particle layer is formed. By said oxide film, a catalyst particle layer can be formed, having both minute grain diameter and uniform particle size. The catalyst metal is a transition metal such as iron (Fe), cobalt (Co), nickel (Ni), molybdenum (Mo), and platinum (Pt). In particular, iron, cobalt, and nickel are preferable. Also, it may be a single kind or a mixture of two kinds or more of these metals.

### <Synthesis Step: Step S4>

In the synthesis step, a raw material gas heated at or above the synthetic temperature of oriented carbon nanotubes is supplied over the catalyst substrate, and oriented carbon nanotubes is synthesized. At that time, a carrier gas is supplied at the periphery of said raw material gas, or at its previous or subsequent stage. The supply of this carrier gas suppresses diffusion of the raw material gas. Preferably, the synthesis concentration region on said catalyst substrate, in which the concentration of the raw material gas has been set to be equal to or higher than the predetermined concentration for growing oriented carbon nanotubes, is set to be smaller in area than the synthesis temperature region over said catalyst substrate, which has been set to be equal to or higher than said synthetic temperature. As for specific example of a synthesis concentration region and a synthesis temperature region, it is described below. In said synthesis concentration region, it is preferable that the raw material gas concentration increase steeply from outside its region. Here, what is facilitated is formation of a region of raw material gas that satisfies uniformly the synthetic condition concerning the concentration and the temperature, where a highly oriented carbon nanotubes can be synthesized more reliably.

### <Synthesis Step: Step S5>:

In the collection step in which oriented nanotubes are collected, the synthesized oriented carbon nanotubes are collected as a product. In the present invention, because substrates are supplied continuously or intermittently, catalyst substrates can be formed sequentially or continuously to be supplied, and oriented carbon nanotubes are synthesized continuously or intermittently to be collected. At the time of collection, the synthesized oriented carbon nanotubes may be detached and collected, or they may be collected in the state in which they remain attached to the catalyst substrate. Also, thread-like carbon nanotube aggregates are formed by raising a part of the densified oriented carbon nanotubes, and by spinning them, the oriented carbon nanotubes are collected.

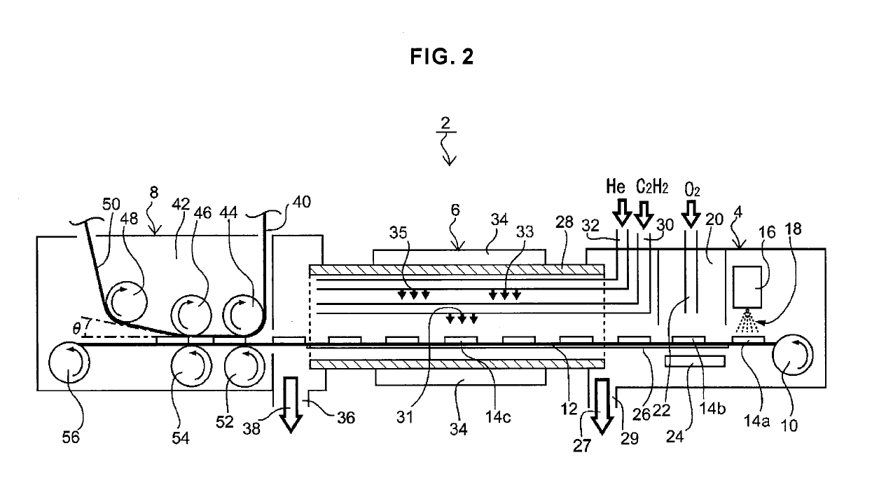

FIG. 2 is an outlined schematic diagram of apparatus for continuously synthesizing oriented carbon nanotubes 2 concerning the first embodiment of the present invention. This apparatus for continuously synthesizing oriented carbon nanotubes 2 consists of coating and drying portion 4, synthesis portion 6, and collection portion 8. It is equipped with a substrate transportation means comprising auxiliary roller 10, main roller 56, and belt 12. Substrates 14a, 14b, 14c for growing oriented carbon nanotubes are transported by this substrate transportation means. Coating apparatus 16 is installed in coating and drying portion 4, and a catalyst film is formed by coating catalyst solution 18 on the surface of substrate 14a. Substrate 14b, on which the catalyst film containing the solvent component has been formed, arrives at drying chamber 20 in coating and drying portion 4, and is heated by heating apparatus 24 for drying. A catalyst layer is formed by evaporating the solvent contained in the catalyst film. Furthermore, oxidizing gas supply port 22 is installed in drying chamber 20, and when it is heated furthermore by said heating apparatus 24 while an oxidizing gas such as oxygen or atmospheric gas is supplied, an oxide film can be formed on the catalyst layer surface. Also, to coating and drying portion 4, an exhaust pump 29 and a pump (not shown) connected to exhaust pump 29 are installed, so that exhaust gas 27 is exhausted, and it prevents the oxygen O2 flowing from oxidizing gas supply port 22 or the oxidizing mixed gas from flowing into synthesis portion 6.

Furthermore, distribution path 28 comprising a quartz tube is installed in synthesis portion 6 of FIG. 2. Heating means 34 to heat the raw material gas, the carrier gas, and the catalyst substrate is installed in this distribution path 28, and catalyst substrate 14c is supplied by said substrate transportation means. In FIG. 2, acetylene gas (C₂H₂ gas) is introduced from raw material gas introduction tube 30 as said raw material gas, and He gas is introduced from carrier gas introduction tube 32 as said carrier gas. The introduced acetylene gas and He gas are heated by said heating means 34, and they are heated until their temperature is maintained at or above the synthesis temperature when they are supplied to the surface of catalyst substrate 14c. As for raw material gas supply port 31 of the central portion, first carrier gas supply port 33 is arranged at its front stage, and first carrier gas supply port 35 is arranged at its rear stage. When acetylene gas is supplied to the surface of catalyst substrate 14c, He gas is supplied so as to bracket it. In addition, exhaust port 36 is installed in the synthesis portion. By decompression inside distribution path 28 by the pump (not shown) connected to it, gas with a given flow rate is supplied to the surface of catalyst substrate 14c. As discussed below, raw material gas supply port 31 is an injection port assembly in which multiple small injection ports are assembled, and each of first and second carrier gas supply ports 33, 35 is also composed of an assembly of injection ports.

In FIG. 2, the concentration of the acetylene gas supplied to the surface of catalyst substrate 14c is set to be equal to or higher than the synthetic concentration in which oriented carbon nanotubes can be synthesized, and at the same time, it is heated by said heating means 34 so that temperature equal to or higher than the synthetic temperature is maintained at the surface of catalyst substrate 14c. Furthermore, because He gas is also heated by said heating means 34 to be equal to or higher than the synthesis temperature, said raw material gas supply port and said carrier gas supply port are arranged so that the synthesis concentration region becomes smaller in area than the synthesis temperature region formed on the surface of catalyst substrate 14c that has been set to be equal to or higher than the synthesis temperature.

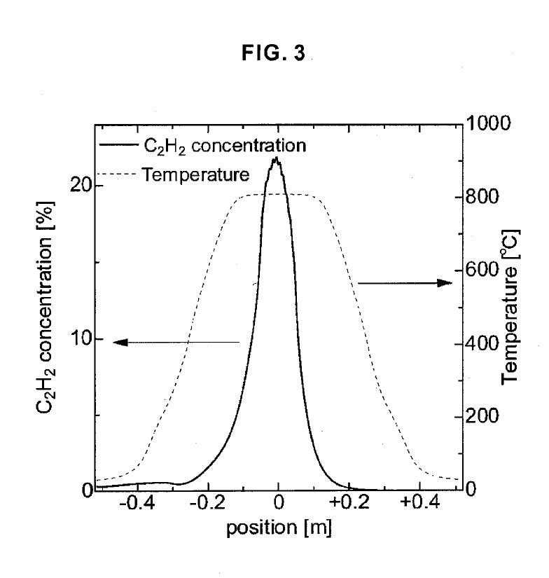

FIG. 3 is a graphical diagram showing the temperature distribution and the acetylene (C₂H₂) concentration distribution on a catalyst substrate surface concerning the present invention. This temperature distribution and acetylene concentration distribution are a simulation result concerning the apparatus for continuously synthesizing oriented carbon nanotubes of FIG. 2, in which acetylene gas heated at or above the synthetic temperature is introduced only from raw material gas supply port 30a of the central portion, and He gas is supplied from first carrier gas supply port 33 and second carrier gas feed path 35. The temperature distribution and acetylene concentration distribution at steady state is calculated by means of a general-purpose heat flow body analysis software applying the finite volume method (FLUENT). As for the result of FIG. 3, a case is calculated for the apparatus in FIG. 2, where the synthesis temperature is set at 800° C., the pressure inside distribution path 28 consisting of a quartz tube is set at 2.7×10³ Pa, acetylene gas of 90 sccm flow rate is introduced from raw material gas introduction tube 30, and He gas of 210 sccm flow rate is introduced from the carrier gas introduction tube. From FIG. 3, it is understood that it is set so that the concentration of acetylene gas increases steeply so that acetylene gas do not come in contact with the catalyst substrates at the front stage of catalyst substrate 14c. An optimal synthesis of oriented carbon nanotubes is achieved when the synthesis concentration is 5% or higher, preferably 10% or higher. In FIG. 3, the region in which the dotted line that indicates the temperature on the surface of the catalyst substrate is 800° C. or greater is defined as the synthesis temperature region, and the region that is included in the full width at half maximum of the acetylene concentration distribution is defined as the synthesis concentration region. The catalyst substrates are transported continuously or intermittently, and the temperature of the catalyst substrates is raised by being transported continuously or intermittently in the carrier gas atmosphere at the time. The catalyst substrates, at the heated step, are transported to the synthesis concentration region continuously or intermittently, and oriented carbon nanotubes are synthesized. By varying the transport rate, the temperature increase rate and the addition rate of the raw material gas to the catalyst substrate can be adjusted.

As is apparent from FIG. 3, the synthesis concentration region, in which the acetylene at or above the synthesis concentration, is set smaller in area than the synthesis temperature region, and it is set so that acetylene gas with temperature equal to or lower than that the synthesis temperature and concentration equal to or higher than the synthesis concentration does not come into contact with a catalyst substrate whose temperature is increasing. In addition, it can be seen that the concentration distribution of acetylene becomes asymmetrical from left to right, and it can be understood that gas is being exhausted from the export side. Also, one can confirm that the acetylene concentration has started to increase until the temperature reaches 800° C., and it is desirable that the synthesis concentration region is made even smaller in area, or the synthesis temperature region is made larger in area, when there is a possibility that a detrimental influence is caused upon the synthesis of oriented carbon nanotubes.

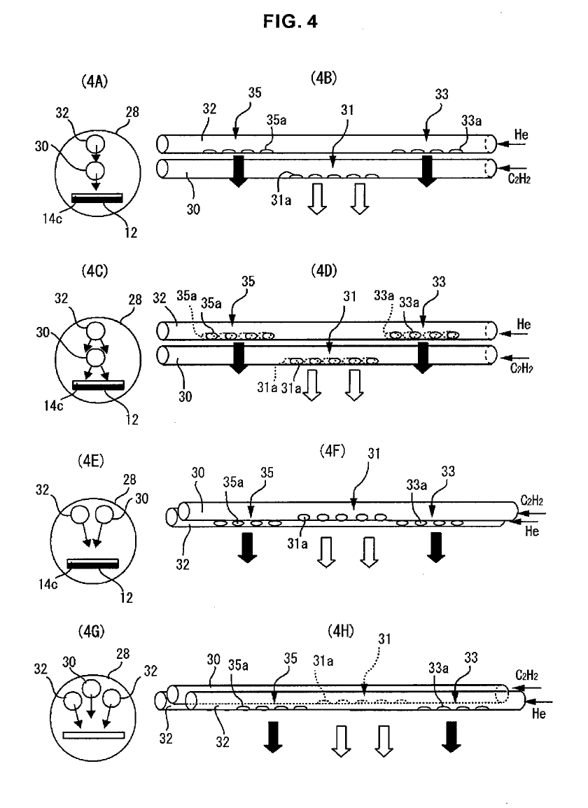

FIG. 4 is an arrangement drawing of a raw material gas introduction tube and a carrier gas introduction tube concerning the present invention. (4A) and (4B) are arrangement drawings in the case where raw material gas introduction tube 30 and carrier gas introduction tube 32 are positioned vertically inside distribution path 28 of said synthesis portion. (4A) is a cross section outlined schematic diagram of distribution path 28, and (4B) is an arrangement drawing showing a side view of raw material gas introduction tube 30 and carrier gas introduction tube 32 in said synthesis portion. As shown in (4A), catalyst substrate 14c is placed on belt 12 that is placed below raw material gas introduction tube 30. In FIG. 4, raw material gas supply port 31 is an aggregate of injection ports comprising a large number of raw material gas injection ports 31a, and similarly, first carrier gas supply port 33 and second carrier gas supply port 35 are composed respectively of an aggregate of large number of injection ports of carrier gas injection ports 33a, 35a.

It is desirable that the injection port aggregates of the raw material gas and the carrier gas have a diameter in which the pressure inside the raw material gas introduction tube or the carrier gas introduction tube can be maintained, and the raw material gas or the carrier gas is ejected toward the catalyst substrate by the pressure difference between the introduction tube and the synthesis concentration region or the synthesis temperature region.

In (4A) and (4B), first carrier gas supply port 33 and second carrier gas supply port 35 are installed respectively at the front and rear stages of raw material gas supply port 31, and at the same time, raw material gas supply port 31, first carrier gas supply port 33, and second carrier gas supply port 35 are formed at the lowermost portion of raw material gas introduction tube 30 and carrier gas introduction tube 32.

In (4C) and (4D), raw material gas supply port 31, first carrier gas supply port 33, and second carrier gas supply port 35 are formed on both sides of raw material gas introduction tube 30 and carrier gas introduction tube 32 so that they bracket the lowermost parts. (4C) is a cross section outlined schematic diagram of distribution path 28, and (4D) is an arrangement drawing of a side view of raw material gas introduction tube 30 and carrier gas introduction tube 32 of said synthesis portion. Furthermore, in (4E) and (4F), raw material gas introduction tube 30 and carrier gas introduction tube 32 are placed side by side, and raw material gas supply port 31, first carrier gas supply port 33, and second carrier gas supply port 35 are formed at the lowermost portions of raw material gas introduction tube 30 and carrier gas introduction tube 32. Similarly, (4E) is a cross section outlined schematic diagram of distribution path 28, and (4F) is an arrangement drawing from an oblique view of raw material gas introduction tube 30 and carrier gas introduction tube 32 in said synthesis portion.

In (4G) and (4H), two carrier gas introduction tubes 32 are placed side by side so as to bracket raw material gas introduction tube 30, and raw material gas supply port 31, first carrier gas supply port 33, and second carrier gas supply port 35 are formed at the lowermost portions of raw material gas introduction tube 30 and two carrier gas introduction tubes 32. (4G) is a cross section outlined schematic diagram of distribution path 28, and (4H) is an arrangement drawing showing an oblique view of raw material gas introduction tube 30 and carrier gas introduction tubes 32 of said synthesis portion. Therefore, in (4G) and (4H), four carrier gas supply ports are installed in the periphery of raw material gas supply port 31.

Furthermore, in apparatus for continuously synthesizing oriented carbon nanotubes 2 shown in FIG. 2, collection portion 6 is installed. In this collection portion 6, transfer member 40 for transferring oriented carbon nanotubes are transported at the same speed as the oriented carbon nanotube substrate on which oriented carbon nanotubes are bonded, and are placed into contact at the same time. Multiple rollers are arranged in collection chamber 42, and the surfaces of transfer member 40 and the oriented carbon nanotube substrate are placed into contact by driving rollers 52, 54 at the lower part and driving rollers 44, 46 at the upper part, and are adhered. Next, separation roller 48 is arranged so that the angle formed by the surfaces of transfer member 40 and the oriented carbon nanotubes comprises a predetermined separation angle θ. The oriented carbon nanotubes are detached from the oriented carbon nanotube substrate, transferred to transfer member 50, and are collected along with transfer member 50. It is preferable to use an adhesive tape for transfer member 40, and when the adhesive strength of the adhesive tape is within a range of 1-100N/10 mm, oriented carbon nanotubes can be relatively easily transferred to the adhesive tape. Also, it is preferable that separation angle is in a range of 30-45°.

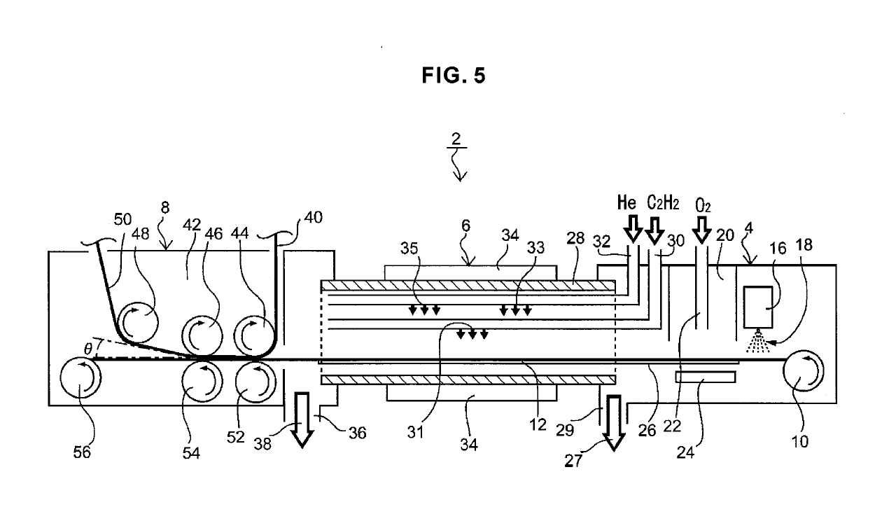

FIG. 5 is an outlined schematic diagram of an apparatus for continuously synthesizing oriented carbon nanotubes concerning the second embodiment of the present invention. In the second embodiment, belt 12 is used as the substrate.

The configuration, aside from belt 12, is same as in FIG. 2, and a further explanation is omitted. However, a flexible metallic material is used for belt 12 that is used as the substrate, and a relatively thin stainless steel plates, among others, can be used as the substrate.

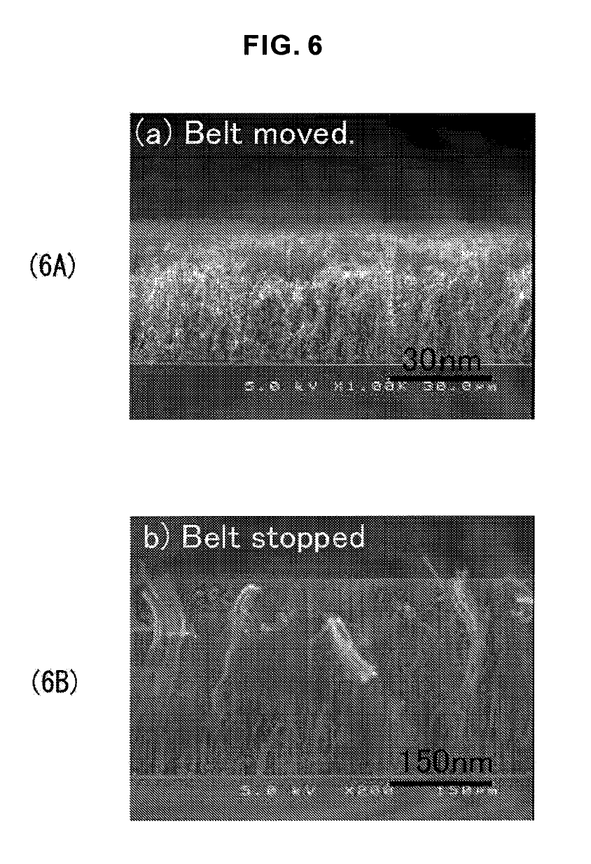

FIG. 6 is observation images of oriented carbon nanotubes synthesized with an apparatus for continuous synthesis of oriented carbon nanotubes concerning the present invention. As shown in (6A) of FIG. 6, after having passed through the apparatus for continuous synthesis, oriented carbon nanotubes with height of about 30 μm are observed on the catalyst substrate surface. They were synthesized by setting the synthesis temperature at 800° C., and the pressure inside distribution path 28 comprising a quartz tube at 2.6×10³ Pa, introducing acetylene gas with 90 sccm flow rate from raw material gas introduction tube 30, and introducing He gas of 210 sccm flow rate from the carrier gas introduction tube. For the heating means of the synthesis portion, an infrared heating apparatus is used. The transportation speed of the belt is 4.8 mm/sec. In addition, a resistance beating apparatus may be used for said heating means, and the heating of the substrate is done by conduction electric heat. (6B) is an observation image of oriented carbon nanotubes synthesized in a state in which the belt was stopped. Oriented carbon nanotubes with average height of about 300 μm was synthesized. That is to say, it was found that the synthetic efficiency of oriented carbon nanotubes improved by stopping the belt at the time of synthesis.

Also, synthesis has been done by applying the above condition, but setting the synthesis temperature at 700° C., and the pressure inside distribution path 28 comprising a quartz tube at 1.0×10¹ Pa, and it has been confirmed that oriented carbon nanotubes were synthesized.

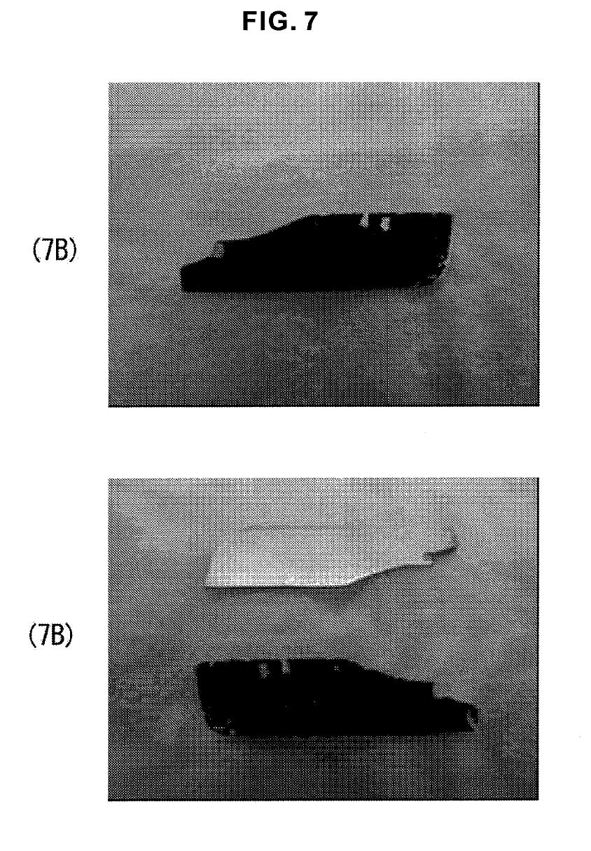

FIG. 7 is photographic figures showing an observation of a transfer condition of oriented carbon nanotubes by a transfer member concerning the present invention. A separability test was carried out using a catalyst substrate (approx. 15 mm width, approx. 30 mm length) on which oriented carbon nanotubes (10 nm diameter, length equal to or greater than 100 um) had been grown, and an adhesive tape (“Cellotape” (trademark) by Nichiban Co., No. 405 Series (18 mm width, 35 m length)) as the transfer member. The feed rate of the oriented carbon nanotube substrate and the adhesive tape was 0.01 m/s, and the separation angle 45°. (7A) is the oriented carbon nanotube substrate, and (7B) is a photographic figure of the substrate after the separation using the adhesive tape (top), and the transferred oriented carbon nanotubes (bottom). Nothing is left on the substrate after the separation, and a complete separation/transfer is accomplished. Also, it was confirmed that oriented carbon nanotubes detach at tensile strength of 0.01 kN.

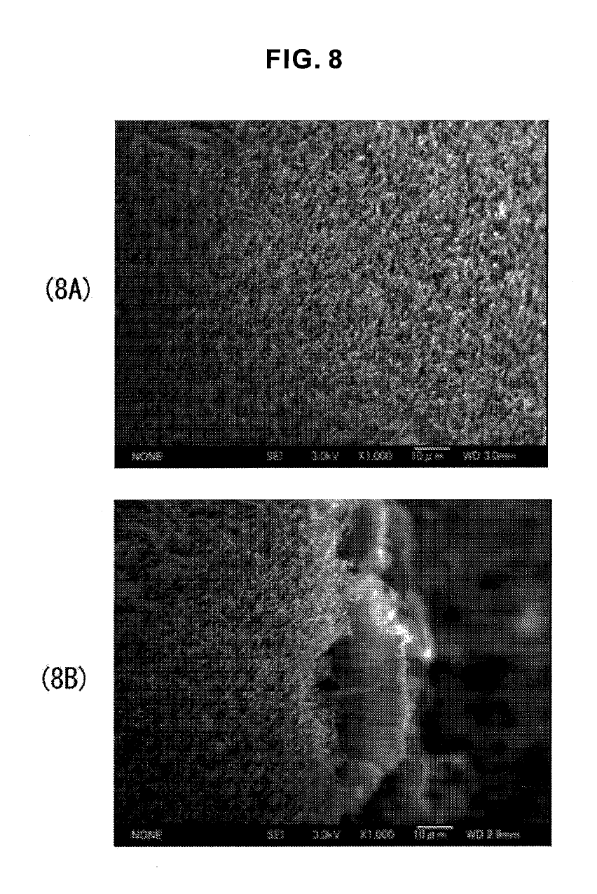

FIG. 8 is electron microscope (SEM) images of oriented carbon nanotubes transferred to an adhesive tape that is a transfer member concerning the present invention. (8A) is an SEM image of the adhesive tape surface after the separation, and (8B) is an SEM image of the adhesive tape end portion side after the separation. As a result of the SEM observation, it could be confirmed that the carbon nanotubes were transferred while they were oriented. As a result of carrying out a similar examination, using “Strong Type” (Cat. No. NW-K15SF) and “Ultra Strong Type” (Cat. No. NW-U15SF) of the “Nice Tack” (trademark) series double-sided tape made by Nichiban Co as the adhesive tape, a similar separation/transfer was accomplished, and it could be confirmed by SEM observation that the carbon nanotube were transferred while maintaining their orientation.

TABLE 1
Adhesive strength of the Nice Tack (trademark)
Series (N/10 mm)

| | |
|---|---|
| Normal | 4.42N/10 mm |
| Strong | 6.40N/10 mm |
| Ultra Strong | 30.6N/10 mm |

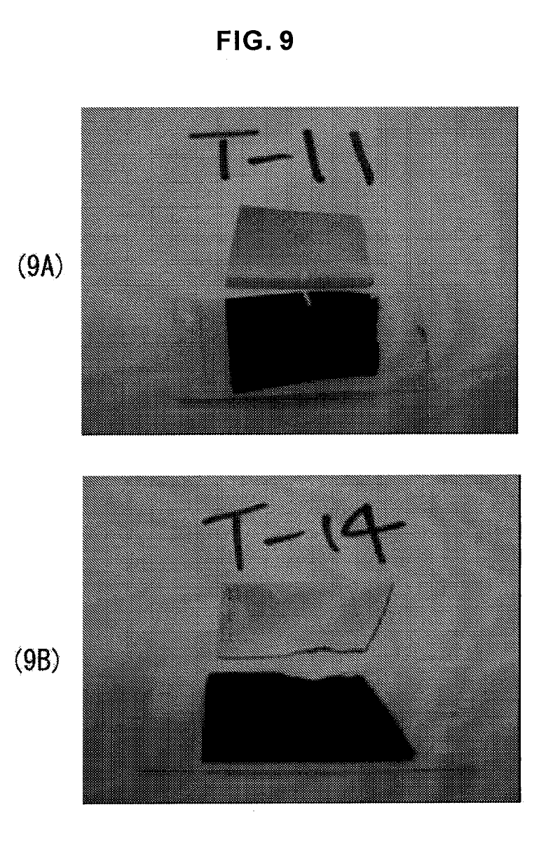

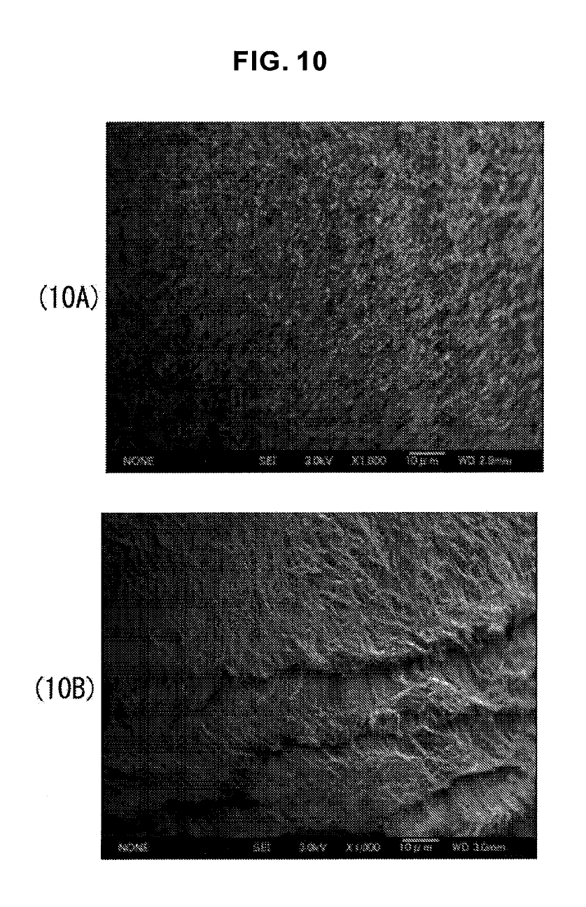

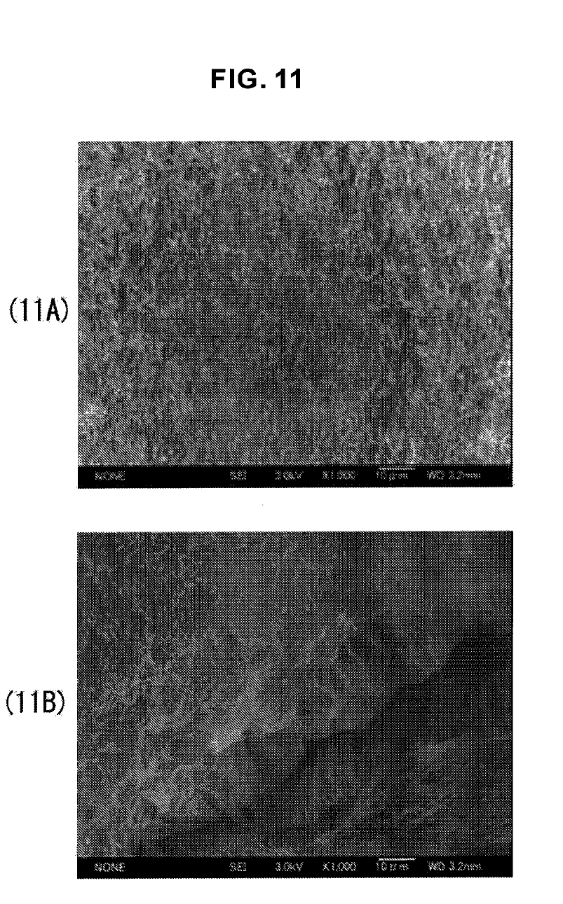

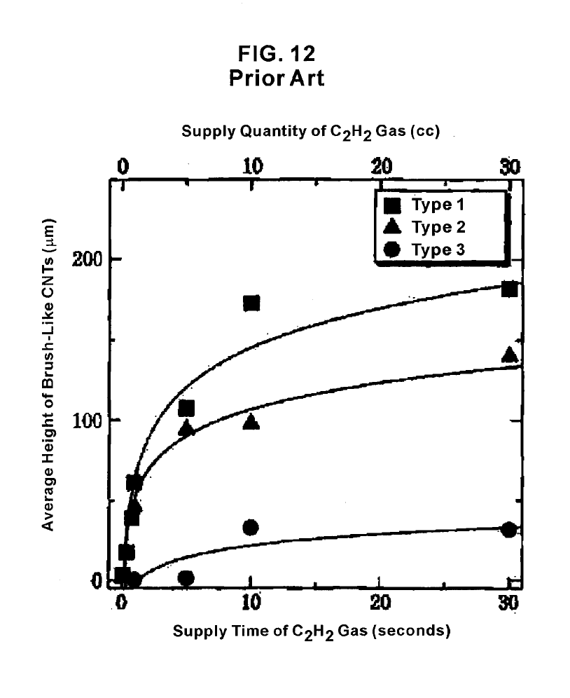

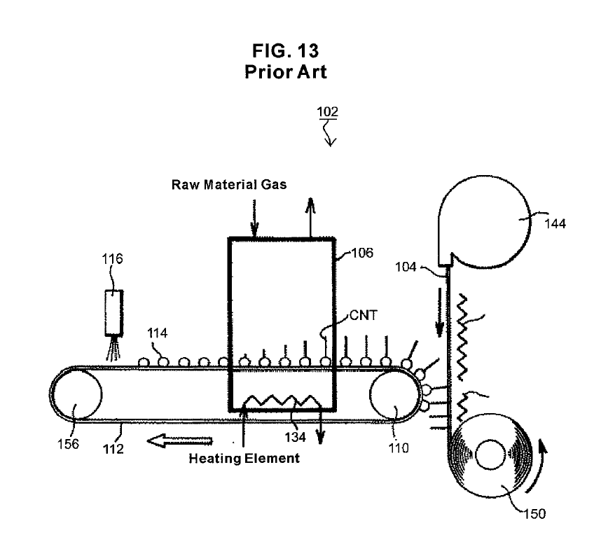

FIG. 9 is photographic figures of an observation of transfer condition of oriented carbon nanotubes by a transfer member concerning the present invention. (9A) is a photographic figure after separation by “Strong Type”, and (9B) is a photographic figure after separation by “Ultra Strong Type”. Also, FIG. 10 is SEM images of the oriented carbon nanotubes transferred by the adhesive tape shown in FIG. 9. In each of (10A) and (10B), an adhesive tape of “Strong Type” (6.40N/10 mm adhesive strength) is used. By these test results, it could again be confirmed that the carbon nanotubes were transferred while maintaining their orientation. FIG. 11 also is SEM images of the oriented carbon nanotubes transferred by the adhesive tape shown in FIG. 9, and in each of (11A) and (11B), an adhesive tape of “Ultra Strong Type” (30.6N/10 mm adhesive strength) is used. Therefore, it was confirmed that, according to the method for continuously synthesizing oriented carbon nanotubes and the apparatus thereof concerning the present invention, synthesized oriented carbon nanotubes can be transferred to commercially available adhesive tapes. The adhesive strength of commercially available adhesive tapes is within a range of 1-100N/10 mm, and various kinds of transfer members can be used as long as they are in this range.

### INDUSTRIAL APPLICABILITY

According to the method for continuously synthesizing oriented carbon nanotubes and the apparatus for continuously synthesizing the same concerning the present invention, one can easily reproduce synthetic conditions for cases in which oriented carbon nanotubes are synthesized continuously, so that oriented carbon nanotubes can be synthesized stably in large quantities.

Therefore, the quality of oriented carbon nanotubes can be improved, and at the same time, a reduction of production cost can be carried out.

### DENOTATION OF REFERENCE NUMERALS

2 Apparatus for continuously synthesizing oriented carbon nanotubes

4 Coating and drying portion

6 Synthesis portion

8 Collection portion

10 Auxiliary roller

56 Main roller

12 Belt

14a Substrate

14b Substrate

14c Catalyst substrate

16 Coating apparatus

18 Catalyst solution

20 Drying chamber

22 Oxidizing gas supply port

24 Heating apparatus

27 Exhaust gas

28 Distribution path

29 Exhaust port

30 Raw material gas introduction tube

31 Raw material gas supply port

31a Raw material gas injection port

32 Carrier gas introduction tube

33 First carrier gas supply port

33a Carrier gas injection port

34 Heating means

35 Second carrier gas supply port

35a Carrier gas injection port

36 Exhaust port

38 Exhaust gas

40 Transfer member

42 Collection chamber

44 Driving roller

46 Driving roller

52 Driving roller

54 Driving roller

48 Separation roller

50 Transfer member

102 Apparatus for manufacturing oriented carbon nanotubes

106 Heating furnace

110 Driving drum

156 Auxiliary drum

112 Endless belt

116 Spray

114 Catalyst particle

134 Heater

1. A method for continuously synthesizing oriented carbon nanotubes in which an oriented carbon nanotube is grown on a catalyst substrate surface while one or more catalyst substrate, on which a catalyst particle layer has been formed, are transported continuously or intermittently, wherein said method comprises:
a coating and drying step in which a catalyst layer is formed on a substrate surface by coating with a catalyst solution and drying, a catalyst substrate formation step in which a catalyst substrate having a catalyst particle layer is formed on said substrate surface by heating said catalyst layer,
a synthesis step in which an oriented carbon nanotube is synthesized by placing a raw material gas that has been heated at or above a synthesis temperature of said oriented carbon nanotube in contact with a surface of said catalyst substrate, and
a collection step in which said oriented carbon nanotube is collected, and
in said synthesis step, a synthesis concentration region over said catalyst substrate, in which a concentration of said raw material gas has been set to be equal to or higher than a predetermined concentration for growing an oriented carbon nanotube, is made to be smaller than a synthesis temperature region over said catalyst substrate that has been set to be equal to or higher than said synthesis temperature.

2. (cancelled)

3. The method for continuously synthesizing oriented carbon nanotubes according to claim 1, wherein an oxide film is formed on a surface of said catalyst layer during said coating and drying step, while an oxidizing gas is supplied or while heating said catalyst layer under an oxidizing gas atmosphere.

4. The method for continuously synthesizing oriented carbon nanotubes according to claim 1 or 3, wherein said substrate is a belt-like substrate, and said oriented carbon nanotube is collected in a state in which it is adhered on said belt-like substrate during said collection step.

5. The method for continuously synthesizing oriented carbon nanotubes according to claim 1 or 3, wherein said collection step is a transfer collection step in which said oriented carbon nanotube is transferred to a transfer member and detached.

6. The method for continuously synthesizing oriented carbon nanotubes according to claim 5, wherein said transfer collection step includes
an adhesion step in which said transfer member is placed in contact through surface with and adhered to a carbon nanostructure substrate surface while said oriented carbon nanotube substrate and said transfer member are transported at a same speed, and
a transfer step in which said oriented carbon nanotube is transferred to said transfer member by separating while transporting said transfer member and said oriented carbon nanotube substrate so that an angle formed by a surface of said transfer member and said oriented carbon nanotube substrate surface is a predetermined separation angle.

7. An apparatus for continuously synthesizing oriented carbon nanotubes, wherein said apparatus comprises:
a substrate transportation means for transporting a substrate for growing an oriented carbon nanotube,
a coating and drying portion for forming a catalyst layer by coating a surface of said substrate with a catalyst solution and drying,
a heating means for heating a raw material gas and a carrier gas at a temperature equal to or higher than a synthetic temperature of said oriented carbon nanotube,
a raw material gas supplying means for supplying said raw material gas and said carrier gas to a surface of a catalyst substrate,
a synthesis portion for synthesizing said oriented carbon nanotube by supplying said raw material gas to a surface of said catalyst substrate on which a catalyst particle layer has been formed by heating said catalyst layer,
a collection portion for collecting said oriented carbon nanotube from said oriented carbon nanotube substrate, and
wherein
said heating means and said raw material gas supplying means are arranged in said synthesis portion,
said raw material gas supplying means comprises one or more raw material gas supply ports and two or more carrier gas supply ports
a synthesis concentration region is formed in a surface of said catalyst substrate transported to said synthesis portion, in which a concentration of said raw material gas is set to be equal to or higher than a predetermined concentration for growing said oriented carbon nanotube,
said raw material gas supply port and said carrier gas supply port are arranged so that said synthesis concentration region becomes smaller than a synthesis temperature region of said catalyst substrate surface that has been set to be equal to or higher than said synthesis temperature, and
said oriented carbon nanotube is synthesized continuously or intermittently.

8. (cancelled)

9. The apparatus for continuously synthesizing oriented carbon nanotubes according to claim 7, wherein an oxidizing gas supplying means for supplying an oxidizing gas to said coating and drying portion is installed.

10. The apparatus for continuously synthesizing oriented carbon nanotubes according to claim 7 or 9, wherein said collection portion is provided therein with:
an adhesive means for placing in contact while transporting a transfer member for transferring said oriented carbon nanotube and said oriented carbon nanotube substrate, so that said transfer member and said oriented carbon nanotube substrate are transported over a predetermined distance in contact condition and adhered, and
a separating means for separating while transporting said transfer member and said oriented carbon nanotube substrate so that an angle formed by said transfer member surface and said oriented carbon nanotube substrate surface becomes a predetermined separation angle

11. The apparatus for continuously synthesizing oriented carbon nanotubes according to claim 10, wherein said transfer member is an adhesive tape, and an adhesive strength of said adhesive tape is in a range of 1,100N/10 mm.

12. The apparatus for continuously synthesizing oriented carbon nanotubes according to claim 10, wherein said separation angle is in a range of 30°-45°.
